(19) United States
(12) Patent Application Publication
(10) Pub. No.: US 2007/0161410 A1
(43) Pub. Date: Jul. 12, 2007

(54) Mobile phone capable of controlling keyboard lock and method therefor

(75) Inventors: Yin-Lung Huang, Taipei (TW); Chia-Min Cheng, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/329,127

(22) Filed: Jan. 11, 2006

(51) Int. Cl. H04B 1/38; H04M 1/00; H04M 9/00

(52) U.S. Cl. 455/565; 379/433.07

(57) ABSTRACT

The present invention discloses a method and a mobile phone capable of controlling a keyboard lock thereof, wherein an optical sensor and a software are installed to the mobile phone, and the software controls the locking and unlocking of the keyboard of the mobile phone according to a light source detected by the optical sensor, such that the keyboard of the mobile phone will be locked automatically, if a user puts a mobile phone in a dark place such as a bag or a pocket; and the keyboard will be unlocked automatically, if the mobile phone is placed in a bright place. In addition, the keyboard of the mobile phone can be locked or unlocked compulsorily according to the original setting of the keyboard lock of the mobile phone set by a user.

### FIELD OF THE INVENTION

The present invention relates to a mobile phone capable of controlling a keyboard lock thereof and the method therefor, and more particularly to a method and a mobile phone having an optical sensor and a software installed thereto, enabling the software to lock or unlock a keyboard of the mobile phone according to a light source detected by the optical sensor.

### BACKGROUND OF THE INVENTION

In recent years, the development of network and communication technologies advances, and thus various high-tech products derived from computers, mobile communication products, and telecommunication network products tend to come with an excellent quality and a reasonable price, and their volume becomes thinner, lighter, shorter and smaller, and their functions are more comprehensive, and the products are easier to carry. These products are appreciated by consumers, and particularly the popular mobile phone has become indispensable to our daily life. The extensive applications of mobile phone communication products shorten the time and distance between people. In addition to meeting the requirements for wireless communications, the mobile phone also provides other recreations and data compilations, such as providing various digital games and database software. Consumers have increasingly high demands for the function of the communication products, as various communication products are constantly introduced to the market. It is an important index to determine whether or not the manufacturing technology of a communication product can lead the industry by evaluating the communication product if it can provide more convenient, effective, and better functions and services.

In the severe competition of the mobile phone market, mobile phones of various different brands have different key settings, or directly design a lock button on the mobile phone for preventing the keyboard on the panel of the mobile phone from being pressed by accident when the mobile phone is put in a bag or a pocket.

However, the arrangements described above still have the following shortcomings:

Since mobile phones of different brands (such as Motorola, and Nokia, etc) have different key settings, therefore users have to look up the user's guide and learn the operation before knowing how to lock the keyboard, and thus causing inconvenience to users.

Even if a user knows how to lock the keyboard of mobile phones of different brands, the user still has to check whether or not he/she forgets locking the keyboard from time to time. If the user forgets to lock the keyboard and puts the mobile phone in a bag or a pocket, a call may be made unintentionally when a dialing key is pressed. It will cause unnecessary wastes of telephone fees to the user and troubles to the receiving party.

Furthermore, after the mobile phone keyboard is locked, users have to manually unlock the keyboard each time before making a call. Such arrangement is very inconvenient to users.

At present, the qualities of different mobile phones are almost the same, and thus it is a key to success to mobile phone manufacturers by adding more features to the mobile phone. If the design of a mobile phone keyboard lock allows users to lock and unlock the keyboard easier and more securely, then it will add a selling point to the mobile phone product and bring more business opportunities, as well as offering a more convenient way of using the keyboard lock to consumers.

### SUMMARY OF THE INVENTION

In view of the shortcomings of the prior art, the inventor of the present invention based on years of experience to conduct extensive researches and experiments, and finally invented a mobile phone capable of controlling a keyboard lock thereof and the method therefor, in hope of using the innovative idea of the invention to overcome the shortcomings and deficiencies of the prior art.

Therefore, it is a primary objective of the present invention to provide a method and a mobile phone for controlling a keyboard lock thereof, such that if a user puts a mobile phone in a dark place such as a bag or a pocket, the keyboard of the mobile phone will be locked automatically, so as to lock the keyboard in a simple, easy, and secured manner and also comply with the requirements of a user-friendly design.

Another objective of the present invention is to provide a design for users to lock the keyboard of the mobile phone without going over the user manual to learn how to lock the keyboard, or worrying about the user's forgetting to lock the keyboard. The design just needs an optical sensor and a software installed to the mobile phone to automatically control the keyboard lock, so as to make the application simpler, easier, and more convenient.

To achieve the foregoing objectives, the technical measure taken by the present invention installs an optical sensor and a software, wherein the software determines the light source detected by the optical sensor and controls the locking and unlocking of a keyboard of the mobile phone. If the optical sensor is turned on, the optical sensor will detect a light value of an ambient light of the mobile phone, and will send the light value to the software being executed. After the software receives the light value, the light value will be compared with a predetermined value stored in the software. The keyboard is then locked or unlocked automatically according to the result of the comparison, so as to achieve the purpose of locking or unlocking the keyboard.

The above and other objects, features and advantages of the present invention will become apparent from the following detailed description taken with the accompanying drawings.

### BRIEF DESCRIPTION OF THE DRAWINGS

FIG. 1 is a flow chart of the present invention; and

FIG. 2 is a schematic view of a structure of the present invention.

### DETAILED DESCRIPTION OF THE PREFERRED EMBODIMENTS

In a method and a mobile phone capable of controlling a keyboard lock in accordance with the present invention, the method is to install an optical sensor and a software to a mobile phone, wherein the software determines a light source detected by the optical sensor to control locking and unlocking statuses of a keyboard of the mobile phone. If the optical sensor is turned on, the following steps will be processed:

Firstly, the optical sensor detects a light value of an ambient light of the mobile phone and sends the light value to the software.

Secondly, the light value is compared with a predetermined value stored in the software after the software has received the light value;

Then, the keyboard is locked or unlocked according to the result of the comparison, so as to achieve the purpose of controlling the locking or unlocking of the keyboard.

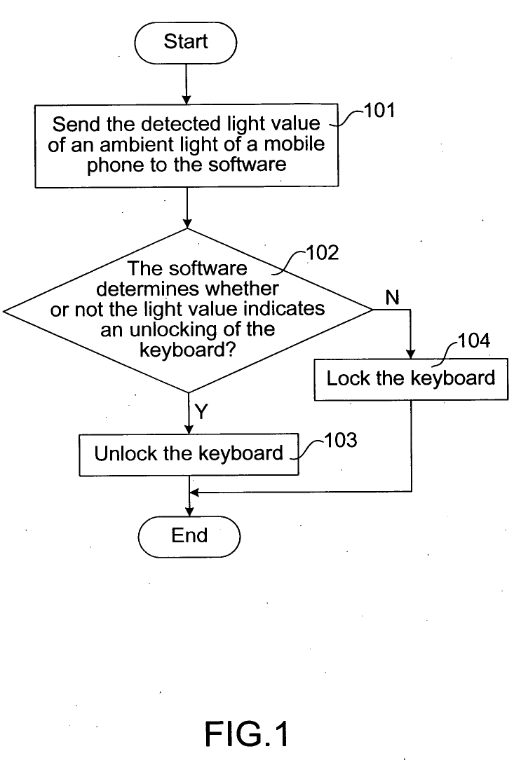

Referring to FIG. 1, a detail procedure of a preferred embodiment of the invention is described as follows:

Step 101: The optical sensor detects a light value of an ambient light and sends the light value to the software.

Step 102: After the software receives the light value, the light value is compared with a predetermined value stored in the software to determine whether or not it is necessary to unlock or lock the keyboard; if yes, carry out Step 103; if no, carry out Step 104.

Step 103: Unlock the keyboard and end the procedure for this time.

Step 104: Lock the keyboard and end the procedure for this time.

In the foregoing procedure of the invention, the ON and OFF statuses of the optical sensor is controlled and selected by an optical sensor functional module option of the mobile phone.

In addition, the control of the mobile phone keyboard lock can be selected by users according to the foregoing method, and the keyboard also can be locked and unlocked compulsorily according to the original settings of the keyboard lock of the mobile phone set by a user.

In the foregoing control method, it is obvious that if a user's mobile phone is turned on, and the optical sensor is set to the ON status, the optical sensor will detect a light value of an ambient light of the mobile phone anytime and will send the detected light value to the software. In other words, the ambient light determines whether or not to lock or unlock the keyboard of a mobile phone. If the mobile phone is placed in a bright place, the keyboard will be unlocked automatically. On the other hand, if the mobile phone is placed in a dark place, the keyboard will be locked. Of course, the keyboard of the mobile phone can be locked or unlocked compulsorily according to the original settings of the keyboard lock of the mobile phone set by users.

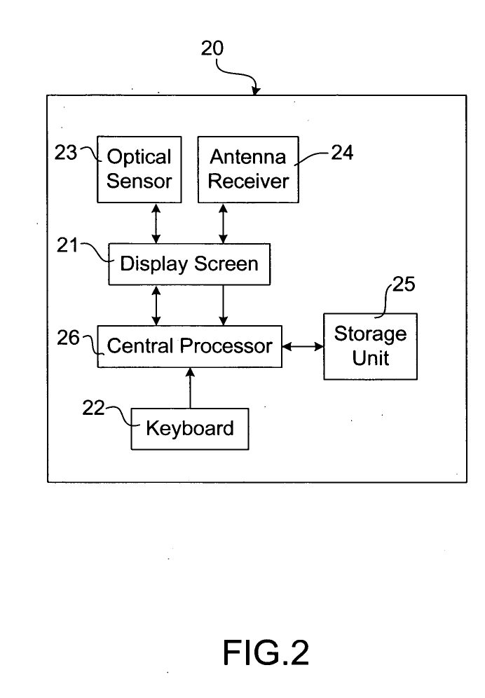

Referring to FIG. 2 for the schematic view of the structure of a mobile phone device constructed by the control method of the present invention, the structure of the mobile phone comprises a casing 20, and the casing 20 includes a display screen 21, a keyboard 22, an optical sensor 23, an antenna receiver 24, and a storage unit 25 thereon.

The display screen 21 is used for displaying information; the keyboard 22 is used for inputting information; the optical sensor 23 is used for detecting an ambient light of the casing 20; the antenna receiver 24 is used for transmitting and receiving a signal; and the storage unit 25 is used for storing a software; wherein the software determines a light source detected by the optical sensor 23, and the result is used for unlocking or locking the keyboard 22, and the display screen 21, keyboard 22, optical sensor 23, antenna receiver 24, and storage unit 25 are controlled and processed by a central processor 26.

Therefore, the method and the mobile phone for controlling the keyboard lock in accordance with the present invention have the following advantages:

1. The keyboard 22 of the mobile phone can be unlocked or locked automatically according to the light detected by the optical sensor 23 of the mobile phone and the determination made by the software.

2. Users can choose whether or not to have an automatic control of the keyboard 22 of the mobile phone.

While the invention herein disclosed has been described by means of specific embodiments, numerous modifications and variations could be made thereto by those skilled in the art without departing from the scope and spirit of the invention set forth in the claims.

What is claimed is:

1. A method for controlling a mobile phone keyboard lock implementing in a mobile phone including an optical sensor and a software, wherein said software is used for determining a light source detected by said optical sensor and controlling to lock and unlock a keyboard on said mobile phone, and said method comprises the steps of:
comparing a light value of an ambient light of said mobile phone detected by said optical sensor with a predetermined value set in said software; and
controlling to lock or unlock said keyboard according to the result of said comparison.

2. The method for controlling a mobile phone keyboard lock of claim 1, wherein said keyboard will be unlocked, if determining that it is necessary to unlock said keyboard.

3. The method for controlling a mobile phone keyboard lock of claim 2, wherein said keyboard will be locked, if determining that it is not necessary to unlock said keyboard.

4. The method for controlling a mobile phone keyboard lock of claim 3, wherein options of turning on and turning off said optical sensor are controlled and selected by an optical sensor functional module option of said mobile phone.

5. A mobile phone capable of controlling keyboard lock, comprising:
a casing;
a display screen, installed on said casing for displaying information;
a keyboard, installed on said casing for inputting information;
an optical sensor, installed on said casing for detecting an ambient light of said casing;
an antenna receiver, installed on said casing for transmitting and receiving a signal;
a storage unit, installed on said casing for storing a software, and said software being used for determining a light detected by said optical sensor and locking or unlocking said keyboard according to the result of said detected light; and
a central processor, installed on said casing for controlling said display screen, said keyboard, said optical sensor, said antenna receiver, and executing said software to lock or unlock said keyboard according to said light detected by said optical sensor.
